(19) United States
(12) Patent Application Publication
(10) Pub. No.: US 2023/0137502 A1
(43) Pub. Date: May 4, 2023

(54) METHOD, DEVICE FOR PROCESSING FEATURE IMAGE AND STORAGE MEDIUM

(71) Applicant: BEIJING BAIDU NETCOM SCIENCE TECHNOLOGY CO., LTD., Beijing (CN)

(72) Inventors: Yingyu JI, Beijing (CN); Yanlong ZHANG, Beijing (CN); Jingjing SUN, Beijing (CN)

(21) Appl. No.: 18/091,704

(22) Filed: Dec. 30, 2022

(30) Foreign Application Priority Data
Mar. 1, 2022 (CN) 202210194618.0

(51) Int. Cl. G06T 5/30; G06T 7/70

(52) U.S. Cl. CPC G06T 5/30; G06T 7/70; G06T 2207/20084

(57) ABSTRACT

A method for processing a feature image includes: grouping parameters in a parameter matrix to obtain a plurality of arrays; the parameter matrix being a matrix converted and obtained from a convolutional layer in a convolutional neural network; performing thinning processing on the parameter matrix according to parameter values in the plurality of arrays to obtain a thinned parameter matrix; performing calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

### CROSS-REFERENCE TO RELATED APPLICATION

This application claims priority to Chinese Patent Application No. 202210194618.0, filed on Mar. 1, 2022, the entire content of which is incorporated herein by reference.

### TECHNICAL FIELD

The present disclosure relates to the technical field of artificial intelligence, specifically the technical fields of deep learning and computer vision.

### BACKGROUND

A deep convolutional network model has a high recognition accuracy for an inputted feature image, and is widely used in face recognition, unmanned driving, machine translation, medical detection and other fields. However, due to the large amount of parameters and long calculation time thereof, it is difficult to meet the requirements of real-time calculation on some embedded chips with low computing power. Therefore, it is often necessary to adopt the method of model compression to achieve accelerated calculation on general hardware devices.

The problem with the current model compression method is that the acceleration benefit is small, or the model accuracy is significantly reduced in the case where the acceleration benefit is met. Therefore, how to achieve better acceleration benefit on general-purpose hardware devices while ensuring model accuracy has become a problem that needs to be solved.

### SUMMARY

According to one aspect of the present disclosure, a method for processing a feature image is provided, which may include the following steps:

grouping parameters in a parameter matrix to obtain a plurality of arrays; the parameter matrix being a matrix converted and obtained from a convolutional layer in a convolutional neural network;

performing thinning processing on the parameter matrix according to parameter values in the plurality of arrays to obtain a thinned parameter matrix;

performing calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

According to another aspect of the present disclosure, an electronic device is provided, which may include:

at least one processor; and

a memory communicatively connected to the at least one processor; wherein

instructions executable by the at least one processor are stored in the memory, and the instructions are executed by the at least one processor, so that the at least one processor can execute the method in any embodiment of the present disclosure.

According to another aspect of the present disclosure, a non-transitory computer-readable storage medium is provided, which stores computer instructions, wherein the computer instructions are configured to cause the computer to execute the method in any embodiment of the present disclosure.

It should be understood that what is described in the present section is not intended to identify key or important features of embodiments of the present disclosure, nor is it intended to limit the scope of the present disclosure. Other features of the present disclosure will be readily understood through the following description.

### BRIEF DESCRIPTION OF THE DRAWINGS

The accompanying drawings are used to better understand the present solution, and do not constitute a limitation to the present disclosure, in which:

FIG. 1 is a flow chart of a method for processing a feature image according to the present disclosure:

FIG. 2 is a schematic diagram of a parameter matrix converted and obtained according to the present disclosure:

FIG. 3 is a schematic diagram 1 of thinning processing according to the present disclosure;

FIG. 4 is a schematic diagram of a data matrix converted and obtained according to the present disclosure:

FIG. 5 is a schematic diagram 1 of grouping parameters in the parameter matrix according to the present disclosure;

FIG. 6 is a schematic diagram 2 of grouping parameters in the parameter matrix according to the present disclosure;

FIG. 7 is an example diagram of parameter grouping according to the present disclosure;

FIG. 8 is a schematic diagram 2 of thinning processing according to the present disclosure;

FIG. 9 is a schematic diagram 1 of determining an output feature map according to the present disclosure;

FIG. 10 is a schematic diagram of performing a matrix operation according to the present disclosure;

FIG. 11 is a schematic diagram 2 of determining an output feature map according to the present disclosure:

FIG. 12 is a schematic diagram of determining second relevant data according to the present disclosure;

FIG. 13 is a schematic diagram of block division operation according to the present disclosure;

FIG. 14 is a schematic diagram of determining block division matrices according to the present disclosure:

FIG. 15 is a structural diagram of an apparatus for processing a feature image according to the present disclosure;

FIG. 16 is a block diagram of an electronic device implementing feature image processing according to an embodiment of the present disclosure.

### DETAILED DESCRIPTION

Exemplary embodiments of the present disclosure will be described below in conjunction with the accompanying drawings, which include various details of the embodiments of the present disclosure to facilitate understanding, and they should be regarded as exemplary only. Accordingly, those of ordinary skill in the art will recognize that various changes and modifications of the embodiments described herein can be made without departing from the scope and spirit of the present disclosure. Also, descriptions of well-known functions and constructions are omitted in the following description for clarity and conciseness.

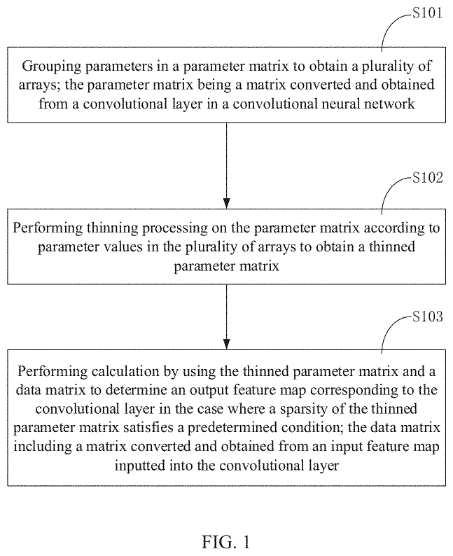

As shown in FIG. 1, the present disclosure relates to a method for processing a feature image, which may include the following steps:

S101: grouping parameters in a parameter matrix to obtain a plurality of arrays; the parameter matrix being a matrix converted and obtained from a convolutional layer in a convolutional neural network:

S102: performing thinning processing on the parameter matrix according to parameter values in the plurality of arrays to obtain a thinned parameter matrix:

S103: performing calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

The present embodiment can be applied to computer devices, specifically including but not limited to servers, desktop computers, notebook computers, cloud computers or a server set composed of a plurality of servers. The present application does not limit product types of computer devices.

Before performing the step S101, respective hidden layers in the convolutional neural network may be recognized first. When the recognition result of the hidden layers is a pooling layer or other non-convolutional layer, general calculation is directly performed on the input feature map.

When the recognition result is a convolutional layer, the step S101 will be performed. Wherein the convolution layer of the convolutional neural network may include a plurality of convolution kernels (w×h×c), w may represent the width, h may represent the height, and c may represent the depth (or the number of channels). Specifically, the sizes of the convolution kernels may be set as required. In the case of a fixed depth value (for example, c=3), the sizes of the convolution kernels may be (1×1×3), (3×3×3), (5×5×3), and so on, which is not done here limited. The number of convolution kernels may also be set as required, for example, 3, 4, 5, and so on.

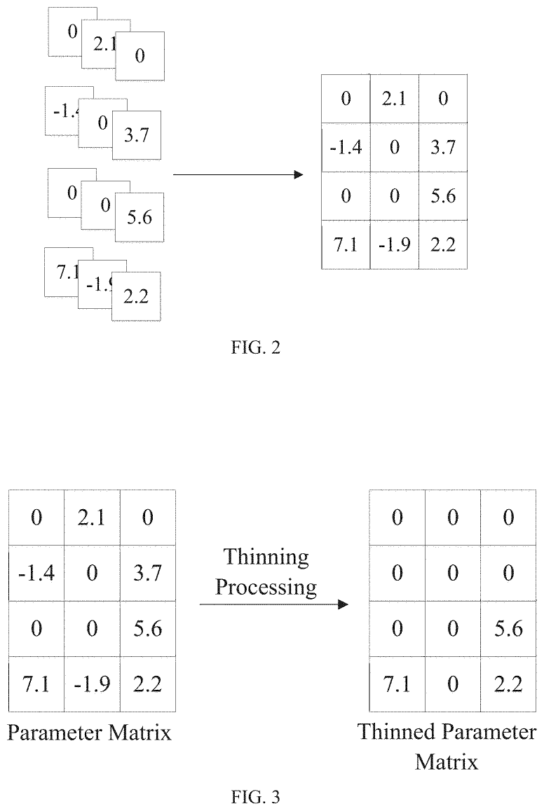

For example, as shown in FIG. 2, in the case of one target convolutional layer containing a number 4 of (1×1×3) convolution kernels, they can be converted into one A4×3 matrix. Therefore, the matrix A4×3 as shown is used as the parameter matrix corresponding to the target convolutional layer.

The step S101 may be implemented by dividing a plurality of continuous parameters in the parameter matrix into one array. Wherein the plurality of continuous parameters may be parameters selected and obtained continuously in a specific direction in the parameter matrix, for example, they may be a plurality of continuous parameters selected and obtained sequentially from left to right, or may also be a plurality of continuous parameters selected and obtained sequentially from top to bottom. The number of parameters in each array may be 2, 4, and so on, which is not limited here.

Preferably, as shown in FIG. 3, two adjacent parameters may be selected from top to bottom in the parameter matrix as one array. For example, (0, −1.4), (2.1, 0), (0, 3.7), and so on, which are not exhaustive here.

After the plurality of arrays are obtained, the step S102 will be performed, in which according to the parameter values in the plurality of arrays, thinning processing will be performed on the parameter matrix, to obtain the thinned parameter matrix. Performing thinning processing on the parameter matrix may be selecting one or more parameter matrices to perform the thinning processing, which is not limited here. Preferably, thinning processing may be performed on each parameter matrix converted and obtained by the convolutional layer. Wherein the parameter values may be the element values of respective elements in the parameter matrix, or may also be the absolute values of the element values, which is not limited here.

Wherein the thinning may be implemented by setting elements with smaller parameter values to zero. For example, as shown in FIG. 3, −1.4, 2.1, 3.7, and −1.9 may be set to zero, thereby obtaining a thinned parameter matrix. Corresponding array values may also be obtained based on the parameter values in the array, and in turn thinning processing will be performed on the parameter matrix by using the array values, which will not be repeated here.

The input feature map may be an image containing feature information of a plurality of dimensions. For example, in the face recognition scenario, the original input feature map may be a feature image containing a face, and a plurality of features, such as texture, edges, colors, and so on, in the face image can be extracted through the processing of a plurality of hidden layers of the convolutional neural network. In addition, usage scenarios may also include other image recognition fields, for example, road image recognition in unmanned driving, machine translation, medical image detection, and so on. Different usage scenarios may have corresponding input feature maps, which will not be repeated here.

The sparsity of the thinned parameter matrix indicates the proportion of the number of the arrays, whose parameter values are all 0, to the total number of the arrays. For example, in the thinned parameter matrix in FIG. 3, the number of the arrays with the parameter values of 0 is 4, and the total number of the arrays is 6, and the sparsity of the thinned parameter matrix is 4/6=66.67%.

In the case where the sparsity of the thinned parameter matrix satisfies a predetermined condition, calculation will be performed by using the thinned parameter matrix and the data matrix, to determine the output feature map corresponding to the convolutional layer; the data matrix including a matrix converted and obtained from an input feature map inputted into the convolutional layer.

The predetermined condition may be that the sparsity is greater than a certain preset threshold, for example, the preset threshold may be 70%. At this time, in the case where the sparsity is greater than 70%, calculation will be performed by using the thinned parameter matrix and the data matrix, and the output feature map will be obtained. The preset threshold may be set as required, for example, it may also be 75%, 80%, and so on, which is not limited here. In addition, the predetermined condition may also be a certain preset range. For example, in the case where the sparsity is located in 50%-70%, calculation will be performed by using the thinned parameter matrix and the data matrix, and the output feature map will be obtained. The value of the preset range can also be set as required, which will not be repeated here.

The data matrix may be a matrix, which is converted and obtained from the input feature map inputted to the convolutional layer, and the size of the data matrix depends on the length, the width, and the number of channels of the three-dimensional input feature map. For the convenience of description, as shown in FIG. 4, assuming that the input feature map is of 3 channels, there are the number 2 of pixels in the length direction, and the number 3 of pixels in the width direction, and the pixels of each channel are expanded and combined sequentially by channels to obtain a B_{3×6} two-dimensional matrix as shown in FIG. 4, which is used as the data matrix.

Through the above process, the convolutional neural network model may be compressed in units of arrays to ensure that the model operation has only a small loss of precision. At the same time, after performing thinning processing based on the parameter values in the arrays, the relevant data in the data matrix can be read by using the parameter distribution in the thinned parameter matrix, which thus can shorten the time required to read the data, and achieve accelerated calculation in the case of model compression.

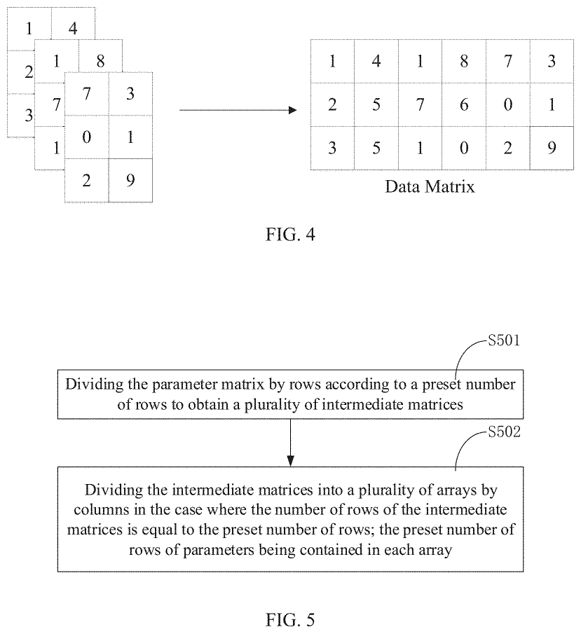

As shown in FIG. 5, in an implementation, the step S101 may include the following sub-steps:

S501: dividing the parameter matrix by rows according to a preset number of rows to obtain a plurality of intermediate matrices;

S502: dividing the intermediate matrices into a plurality of arrays by columns in the case where the number of rows of the intermediate matrices is equal to the preset number of rows; the preset number of rows of parameters being contained in each array.

The dividing the parameter matrix by rows according to the preset number of rows to obtain a plurality of intermediate matrices includes dividing the parameter matrix into a plurality of intermediate matrices sequentially from top to bottom according to the preset number of rows, and the number of columns of the intermediate matrices obtained by division is the same as the number of columns of the parameter matrix. Wherein the preset number of rows may be 2 rows, 4 rows, 6 rows, and so on, which is not limited here.

For example, in the case where the thinned parameter matrix is exactly divided into a number n of matrices according to the preset number of rows, all the number n of matrices are used as the intermediate matrices. In the case where the number of rows of the first n−1 matrices obtained by division is equal to the preset number of rows, and the number of rows of the nth matrix is less than the preset number of rows, a plurality of one-dimensional matrices obtained by further dividing the nth matrix may be used as intermediate matrices.

In the case where the number of rows of the intermediate matrices is equal to the preset number of rows, the intermediate matrices will be divided into a plurality of arrays by columns; the preset number of rows of parameters being contained in each array.

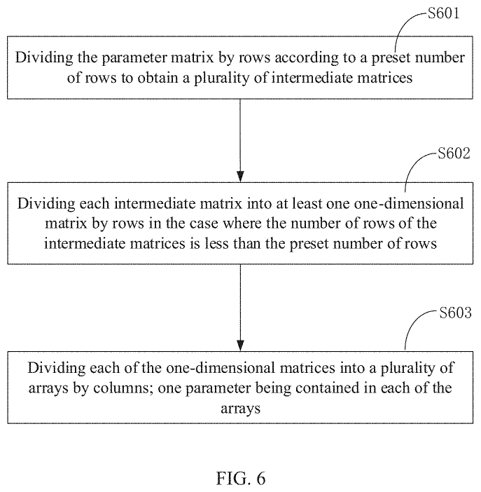

As shown in FIG. 6, in an implementation, the step S101 may include the following sub-steps:

S601: dividing the parameter matrix by rows according to a preset number of rows to obtain a plurality of intermediate matrices;

S602: dividing each intermediate matrix into at least one one-dimensional matrix by rows in the case where the number of rows of the intermediate matrices is less than the preset number of rows:

S603: dividing each of the one-dimensional matrices into a plurality of arrays by columns; one parameter being contained in each of the arrays.

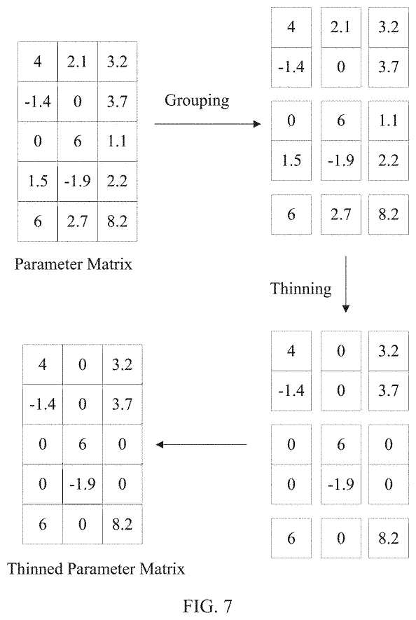

For example, as shown in FIG. 7, the parameter matrix is a matrix with a size of 5×3. In the case where the preset number of rows is 2, the parameter matrix is divided into a plurality of intermediate matrices, each with 2 rows, sequentially from top to bottom, and the last matrix with fewer than 2 rows is used as a separate intermediate matrix. Wherein the size of the first and second intermediate matrices is 2×3, and the size of the third intermediate matrix is 1×3. The three intermediate matrices are then divided into a plurality of arrays by columns. Wherein each intermediate matrix contains 3 arrays. Each array in the first and second intermediate matrices contains 2 parameters, and each array in the third intermediate matrix contains 1 intermediate parameter.

In addition, in the case where the preset number of rows is 4, the nth matrix with the number of rows of less than 4 may be divided into one two-dimensional matrix and a plurality of one-dimensional matrices, or directly divided into a plurality of one-dimensional matrices, which is not limited here. In the case where the preset number of rows takes other values, the specific division method will not be repeated here.

Through the above process, a plurality of arrays can be obtained by grouping the parameters in the parameter matrix. In this way, thinning processing can be performed on the parameter matrix based on the obtained arrays to realize model compression, and then to perform accelerated calculation based on the compressed model.

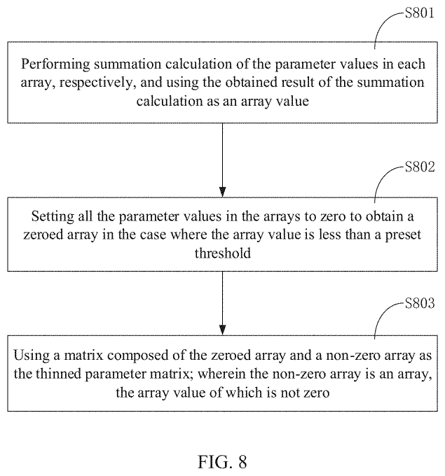

As shown in FIG. 8, in an implementation, the step S102 may include the following sub-steps:

S801: performing summation calculation of the parameter values in each array, respectively, and using the obtained result of the summation calculation as an array value;

S802: setting all the parameter values in the arrays to zero to obtain a zeroed array in the case where the array value is less than a preset threshold;

S803: using a matrix composed of the zeroed array and a non-zero array as the thinned parameter matrix; wherein the non-zero array is an array, the array value of which is not zero.

The step S801 may be implemented by traversing the plurality of arrays in the thinned parameter matrix. Specifically, the traversal may be performed by rows, and after traversing to the last array in a row, the traversal continues from a new row. Alternatively, it is also possible to traverse by columns, which is not limited here. After the respective parameter values in the parameter matrix are obtained by traversing, a summation calculation will be performed on the parameter values in each array and the obtained summation result will be used as the array value. And the arrays in the parameter matrix will be determined, whose array values are less than the preset threshold, and the parameters therein will be set to zero. Specifically, in the case where the parameter values in the array are only positive numbers, the preset threshold may be a positive integer such as 3, 4, 5, and so on, or the preset threshold may be set to a decimal as required, which is not limited here. In the case where the parameter values in the array have positive and negative numbers, the parameters, the sum of the absolute values of which is smaller than the preset threshold, in the array in the parameter matrix, are set to zero. Wherein the preset threshold may be 6, 7, 8, etc., which is not limited here.

The array, whose parameter values are all set to zero, is used as a zeroed array, and the array, whose array values are not zero, is used as a non-zero array. Then the matrix composed of the zeroed arrays and the non-zero arrays is used as the thinned parameter matrix. As shown in FIG. 7,

Through the above process, the thinning processing of the parameter matrix can be completed in units of arrays, and in turn the data can be read and calculated in units of arrays. In this way, the calculation efficiency of the model can be significantly improved under the premise of ensuring the calculation accuracy.

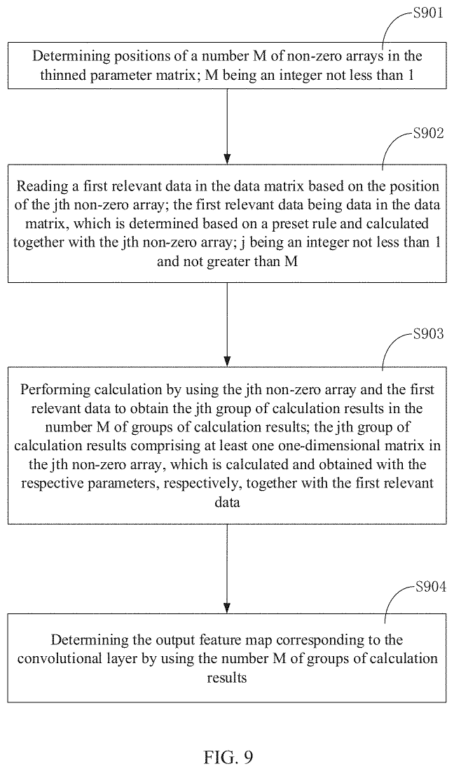

As shown in FIG. 9, in an implementation, the step S103 may include the following sub-steps:

S901: determining positions of a number M of non-zero arrays in the thinned parameter matrix; M being an integer not less than 1;

S902: reading a first relevant data in the data matrix based on the position of the jth non-zero array: the first relevant data being data in the data matrix, which is determined based on a preset rule and calculated together with the jth non-zero array; j being an integer not less than 1 and not greater than M;

S903: performing calculation by using the jth non-zero array and the first relevant data to obtain the jth group of calculation results in the number M of groups of calculation results; the jth group of calculation results comprising at least one one-dimensional matrix in the jth non-zero array, which is calculated and obtained with the respective parameters, respectively, together with the first relevant data;

S904: determining the output feature map corresponding to the convolutional layer by using the number M of groups of calculation results.

Wherein the position of the jth non-zero array in the thinned parameter matrix may be determined when traversing the thinned parameter matrix, where j is an integer not less than 1. Specifically, the non-zero arrays in the thinned parameter matrix may be sequentially read by the register, and when the array value is 0, the register will automatically skip the array and reads the next non-zero array. Wherein the position of the non-zero array may be represented by using the parameter position in the array, for example, the first array is located in column 1 and rows 1-2.

After the positions of the number M of non-zero arrays are determined, based on the position of the jth non-zero array, the first relevant data in the data matrix is read. Wherein the data matrix may be stored in a corresponding storage space, which may for example be a cache memory, which is not limited here.

After locating the non-zero arrays in the thinned parameter matrix, based on the position of the jth non-zero array, the first relevant data in the data matrix will be read. The first relevant data is the data, which is determined based on the preset rule and calculated together with the jth non-zero array. First, based on preset rule, the position of the first relevant data in the data matrix may be determined from the position of the jth non-zero array in the thinned parameter matrix. Secondly, the first relevant data may be read based on the position of the first relevant data in the data matrix and an operation may be performed.

The preset rule may include at least one of a first preset rule and a second preset rule. Wherein the first preset rule may be to determine the column number of the first relevant data in the block division matrix according to the row number of the parameter in the jth non-zero array in the thinned parameter matrix; and the second preset rule may be to determine the row number of the first relevant data in the block division matrix according to the column number of the jth non-zero parameter in the thinned parameter matrix.

Specifically, assuming that the first non-zero array contains two parameters, which are located in the first row, the first column and the second row, the first column, then the element in the first row and the first column may be multiplied with the elements in the first row in the data matrix sequentially, and the element in the second row and the first column in the thinned parameter matrix are multiplied with the elements of the first row in the data matrix sequentially. Therefore, based on the column numbers of the parameters in the first array in the thinned parameter matrix, the row number of the first relevant data in the data matrix, which is calculated together with it, can be determined, and the obtained row number can be used as the position of the first relevant data in the data matrix. Similarly, the first relevant data, of the parameters of other non-zero arrays in the thinned parameter matrix, in the data matrix can be determined.

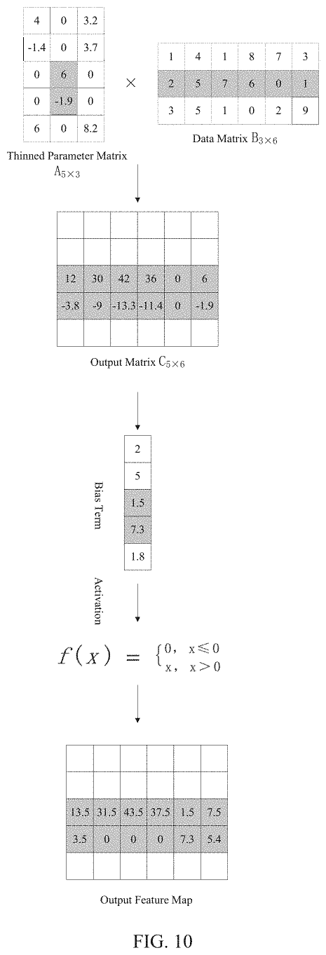

Thus, the rule for determining the position of the first relevant data in the data matrix may be that, the column number of the jth non-zero array in the thinned parameter matrix is used as the row number of the first relevant data in the data matrix. To simplify the description, as shown in FIG. 10, the A_{5×3} matrix represents the thinned parameter matrix, and the B_{3×6} matrix represents the data matrix. The thinned parameter matrix includes 7 non-zero arrays, which respectively are (4, −1.4), (3.2, 3.7), (6, −1.9), 6, 8.2, wherein the two parameters in the first non-zero array are respectively “4” located in the first row and the first column and “−1.4” located in the second row and the first column, and the parameter positions of other arrays will not be repeated here. Correspondingly, the first row of data in the data matrix is the first relevant data of “4” and “−1.4” in the first non-zero array; Similarly, the second non-zero array “3.2” and “3.7” in the A_{5×3} matrix are respectively located in the first row and the third column and the second row and the third column, and the third row of data in the data matrix is its corresponding first relevant data. The third non-zero array “6” and “−1.9” in the A_{5×3} matrix are respectively located in the third row and the second column and the fourth row and the second column, and the second row of data in the data matrix is its corresponding first relevant data. The first relevant data corresponding to other non-zero arrays will not be described one by one.

After the first relevant data is determined, calculation will be performed by using the parameter values of the jth non-zero array in the thinned parameter matrix and the first relevant data in the data matrix. When performing matrix operation, “4” and “−1.4” in the first non-zero array in the A_{5×3} matrix are located in the first column, and “4” and “−1.4” are respectively multiplied with the parameters in the first row in the B_{3×6} matrix sequentially, to obtain two one-dimensional matrices; the second non-zero arrays “3.2” and “3.7” in the A_{5×3} matrix are located in the third column, and are respectively multiplied with the parameters in the third row in the B_{3×6} matrix sequentially, to also obtain two one-dimensional matrices; the third non-zero array “6” and “−1.9” in the A_{5×3} matrix are located in the second column, and are respectively multiplied with the parameters in the second row of the B_{3×6} matrix sequentially, to also obtain two one-dimensional matrices. Calculation of other non-zero arrays and corresponding first relevant data will not be repeated one by one. In the case where only one parameter is included in the non-zero array, calculation will be performed from this only parameter and the corresponding first relevant data to obtain one one-dimensional matrix.

Each group of calculation results includes at least one one-dimensional matrix, and the output feature map corresponding to the convolutional layer will be determined by using the number M of groups of calculation results.

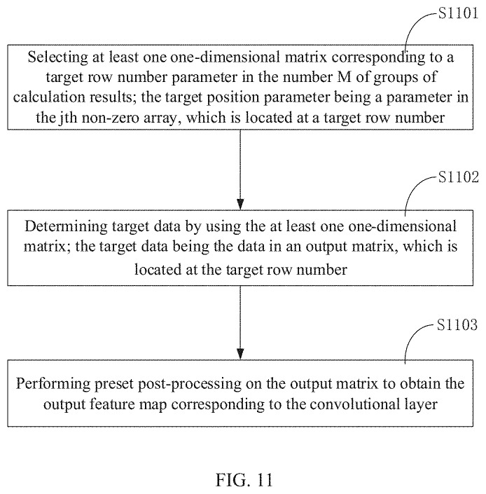

As shown in FIG. 11, in an implementation, the step S904 may include the following sub-steps:

S1101: selecting at least one one-dimensional matrix corresponding to a target row number parameter in the number M of groups of calculation results; the target position parameter being a parameter in the jth non-zero array, which is located at a target row number:

S1102: determining target data by using the at least one one-dimensional matrix; the target data being the data in an output matrix, which is located at the target row number:

S1103: performing preset post-processing on the output matrix to obtain the output feature map corresponding to the convolutional layer.

The number M of groups of calculation results include a plurality of one-dimensional matrices, wherein the plurality of one-dimensional matrices include at least one one-dimensional matrix obtained by calculation based on the target row number parameter. The target row number may be any row number, which is not greater than the row number of the output matrix, such as the first row, the second row, and so on, which is not limited here. For example, in the first non-zero array in FIG. 10, calculation is performed by using the parameter “4” located in the first row together with the first relevant data, and the obtained one-dimensional matrix is a one-dimensional matrix corresponding to the parameter in the first row. And in the second non-zero array, calculation is performed by using the parameter “3.2” located in the first row together with the first relevant data, and the obtained one-dimensional matrix is also a one-dimensional matrix corresponding to the parameter in the first row. And the target data located in the first row of the output matrix will be obtained by summing two one-dimensional matrices.

Similarly, calculation will be performed by using “−1.4” and “3.7” located in the second row together with the data matrix, respectively, to obtain two one-dimensional matrices, and then they are summed to obtain the target data located in the second row of the output matrix. And calculation will be performed by using “6” and “−1.9” located in the third row and the fourth row together with the data in the second row of the data matrix to obtain two one-dimensional matrices, which are respectively used as the target data located in the third row and the fourth row of the output matrix. By analogy, using the thinned parameter matrices A_{5×3} and B_{3×6}, the output matrix obtained by calculation is the output matrix of C_{5×6}.

Preset post-processing will be performed on the output matrix to obtain the output feature map corresponding to the convolutional layer. Wherein the preset post-processing may be inputting the output matrix into a preset activation function, or inputting the output matrix after adding a bias term into a preset activation function to obtain the output feature map. As shown in FIG. 10, the bias item may be a column of parameters with the same number of rows as the output matrix, wherein the parameters may be set as required, which is not limited here. The activation function may be a preset relu function, and the form of the relu function may be:

$$f ( x ) = \{ \begin{matrix}0 , x ⩽ 0 \\ x , x > 0\end{matrix}$$

The form of the relu function can also be set in other ways as required, which is not limited here.

Through the above process, the step of extracting relevant data in the data matrix corresponding to the array values of 0 will be skipped, and at the same time, based on the parameters of the same column in the non-zero array of the thinned parameter matrix, the first relevant data can be extracted, and then calculation can be performed respectively together with different parameters in the array to obtain intermediate results, which avoids the problem of inefficiency caused by extracting different first relevant data in the data matrix based on parameters of different columns.

In one embodiment, a second relevant data in the data matrix will be written into a cache memory in the course of performing calculation by using the jth non-zero array and the first relevant data; wherein the second relevant data is data, which is determined based on the preset rule and calculated together with the j+1th non-zero array.

For example, as shown in FIG. 10, when performing operations by using the thinned parameter matrix and the data matrix, first, the first relevant data corresponding to the first non-zero array (4, −1.4) (column 1, row 1-2) will be extracted and entered into the cache memory, and a corresponding operation will be performed. In the process of performing the operation, the second relevant data corresponding to the next non-zero array (3.2, 3.7) (column 3, row 1-2) can be extracted from the memory and entered into the cache memory, to be prepared for the execution of the operations of the next stage. For the data matrix, the execution subject will skip the rows corresponding to the array values of 0, jump directly to the third row after extracting the first row of data and performing the operation, and the third row of data will be extracted and entered into the cache memory and the next operation will be executed.

Specifically, in the process of performing calculation by using the first non-zero array (4, −1.4) and the first relevant data (1, 4, 1, 8, 7, 3), the second relevant data (3, 5, 1, 0, 2, 9) calculated together with the second non-zero array (3.2, 3.7) will be written into the cache memory. Similarly, in the process of performing corresponding calculation by using the second non-zero array, the data calculated together with the third non-zero array will be written into the cache memory, which will not be described in detail.

Through the above process, based on the positions of the non-zero arrays in the thinned parameter matrix, the step of extracting relevant data in the data matrix corresponding to the array values of 0 will be skipped, avoiding invalid calculation by the execution subject. At the same time, in the current calculation process, the data to be calculated is entered into the cache memory in advance by means of data prefetching, which greatly improves the calculation speed of the network model.

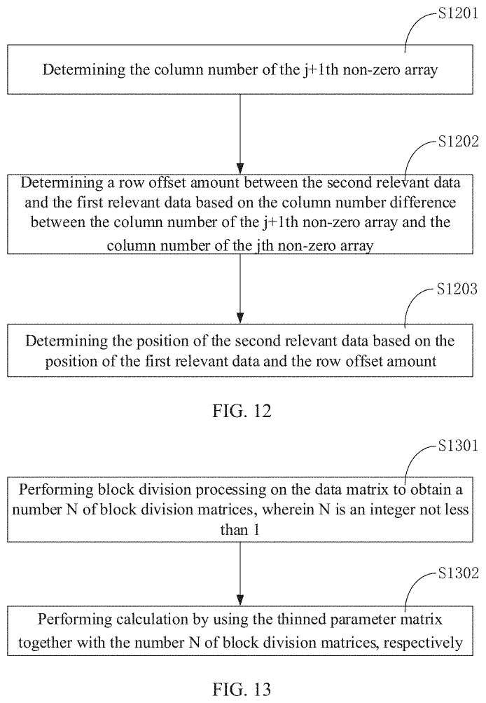

As shown in FIG. 12, in one embodiment, the determining method of the second relevant data may include:

S1201: determining the column number of the j+1th non-zero array;

S1202: determining a row offset amount between the second relevant data and the first relevant data based on the column number difference between the column number of the j+1th non-zero array and the column number of the jth non-zero array:

S1203: determining the position of the second relevant data based on the position of the first relevant data and the row offset amount.

Wherein the j+1th non-zero array may be an array belonging to the same intermediate matrix as the jth non-zero array, or may be a non-zero array of other intermediate matrices, which is not limited here. The column number of the j+1th non-zero array may be any column number not greater than the number of columns of the thinned parameter matrix, such as the 1st column, the 2nd column, and so on, which is not limited here.

The column number difference between the column number of the j+1th non-zero array and the column number of the jth non-zero array may be a positive number or a negative number, which is not limited here. The row offset amount between the second relevant data and the first relevant data is equal to the column number difference, and may also be a positive number or a negative number, which is not limited here.

The position of the first relevant data may be represented by the row number of the first relevant data, and specifically may be any row number, which is not greater than the row number of the data matrix. An implementation manner of determining the position of the second relevant data may be to determine the row number of the second relevant data according to the row number of the first relevant data and the row offset amount. Wherein the row number of the second relevant data obtained by calculation may also be any row number, which is not greater than the row number of the data matrix.

For example, as shown in FIG. 10, the thinned parameter matrix includes the number 5 of non-zero arrays, and the column numbers respectively are 1, 3, 2, 1, 3, the column number difference between the second non-zero array (3.2, 3.7) and the first non-zero array (4, −1.4) is “+2”, the column number difference between the third non-zero array (6, −1.9) and the second non-zero array (3.2, 3.7) is “−1”, and by analogy, the column number differences between the j+1th non-zero array and the j-th non-zero array are “2, −1, −1, 2” respectively. The first data calculated together with the first non-zero array is the data located in the first row of the data matrix, and the row offset amount of the second relevant data determined based on the column number difference is 2, and it can thus be determined that the second relevant data is located in the third row of the data matrix. Similarly, the positions of other second relevant data can be determined, which will not be described here.

Through the above process, the row offset amount between the next second relevant data and the previous second relevant data can be obtained based on the column number difference. In this way, the second relevant data can be quickly located, and the efficiency of data prefetching can be improved, thereby increasing the speed of the entire model operation.

As shown in FIG. 13, in an implementation, the step S103 may also include the following sub-steps:

S1301: performing block division processing on the data matrix to obtain a number N of block division matrices, wherein N is an integer not less than 1:

S1302: performing calculation by using the thinned parameter matrix together with the number N of block division matrices, respectively.

The data matrix obtained by input feature map conversion contains a large number of elements, thus occupying a large storage space, which often exceeds the capacity value corresponding to the cache memory in the execution subject. In the present embodiment, the original data matrix can be decomposed into a plurality of block division matrices through matrix block division processing, wherein each block division matrix contains a small number of elements and occupies a small storage space. Specifically, the block division processing may be to perform block division on the data matrix according to the fixed number of rows and the fixed number of columns, or may also be to perform block division on the data matrix by columns/rows in the case where the number of rows/the number of columns remains unchanged, which is no limited here.

The number N of block division matrices may be obtained by performing block division processing on the data matrix, wherein N may be 1, 2, 3, and so on, which is not exhaustive here.

Using the thinned parameter matrix and the data matrix to perform operations can be transformed into using the thinned parameter matrix to perform operations together with the number N of block division matrices, respectively. Specifically, calculation may be performed by using the thinned parameter matrix together with the number N of block division matrices, respectively, to obtain corresponding block division calculation results, and then the block division settlement results will be spliced according to the positional relationship of the block division matrices, and the result obtained by splicing will be used as the output matrix. The method of determining the first relevant data and the second relevant data in the block division matrix is the same as that of the aforementioned data matrix, and will not be repeated here.

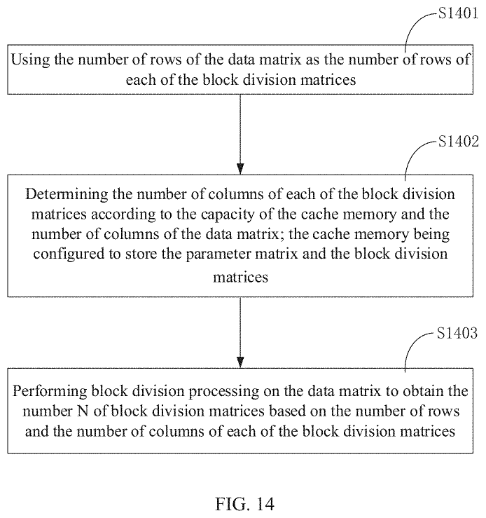

As shown in FIG. 14, in one embodiment, the step S1301 may also include the following sub-steps:

S1401: using the number of rows of the data matrix as the number of rows of each of the block division matrices;

S1402: determining the number of columns of each of the block division matrices according to the capacity of the cache memory and the number of columns of the data matrix; the cache memory being configured to store the parameter matrix and the block division matrices;

S1403: performing block division processing on the data matrix to obtain the number N of block division matrices based on the number of rows and the number of columns of each of the block division matrices.

In the present embodiment, the execution subject can acquire the parameters of the hardware device. For example, the storage capacity information of the hardware device can be acquired by directly reading the cache memory of the hardware device, and the peak memory bandwidth and the maximum operation amount per second of the hardware device can also be acquired, which are not limited here.

In the case where the size of the input feature map is large, the cache memory in the terminal device cannot store the entire data matrix, or a cache miss of the data stored online will be caused as the calculation proceeds. Based on this, block division processing can be performed on the data matrix, and data storage and calculation can be performed in combination with the expected method for data. Specifically, after the pixels of each channel are expanded by channels and sequentially combined in the row direction, block division can be performed on the data matrix by columns. At this time, since the number of columns of the obtained data matrix is much larger than the number of rows, a plurality of smaller block division matrices can be acquired by block division by columns in the case where the number of rows remains unchanged. For example, in the case where the input feature map includes 100 pixel points in the length and width directions, respectively, if the number of channels is 100, the number of columns of the data matrix is 10000, and at this time, block division can be performed on the data matrix by columns to obtained a plurality of block division matrices.

Specifically, the rule of block division processing may be that the number of rows of the data matrix is taken as the number of rows of each block division matrix, that is, the number of rows remains unchanged after block division processing. Further, according to the capacity of the cache memory and the number of columns of the data matrix, the number of columns of each block division matrix will be respectively determined.

For example, in the case where the storage space occupied by the data matrix is 1.8 G, if the capacity of the cache memory is 1 G, the storage space occupied by each block division matrix obtained after block division on the data matrix should be less than 1 G (the cache space occupied by other applications will be not be considered). For example, if the number of columns of the data matrix is 10000, and the memory corresponding to the parameter values of the number m of columns is determined to be only 600 M through calculation, then block division can be performed on the data matrix by m columns to obtain a plurality of block division matrices (m columns). The value of m may be 48, 32, 16, 8, 4, 1, etc., which is not limited here. If the value of m is 48, the data matrix with the number of columns of 10000 can be split into the number 208 of block division matrices with the number of columns of 48. At this time, the remaining 16 columns can be used as the last block division matrix to perform corresponding operations.

After determining the number of rows and the number of columns of each block division matrix, block division processing can be performed on the data matrix based on the number of rows and the number of columns to obtain the number N of block division matrices.

Through the above process, the cache memory can store the complete block division matrices, which avoids the problem of cache loss of relevant data stored online caused by an excessively large data matrix.

In one embodiment, in the case where the sparsity of the thinned parameter matrix does not meet the predetermined condition, the parameter matrix and the data matrix are used for calculation.

The predetermined condition may be a certain preset threshold or a certain preset range, which is not limited here. For example, by comparing the sparsity of the thinned parameter matrix with the size of the preset threshold, for the convolutional layer with a smaller sparsity, corresponding operations will be performed directly in a way of sequential read, which further improves the calculation speed of the convolutional neural network.

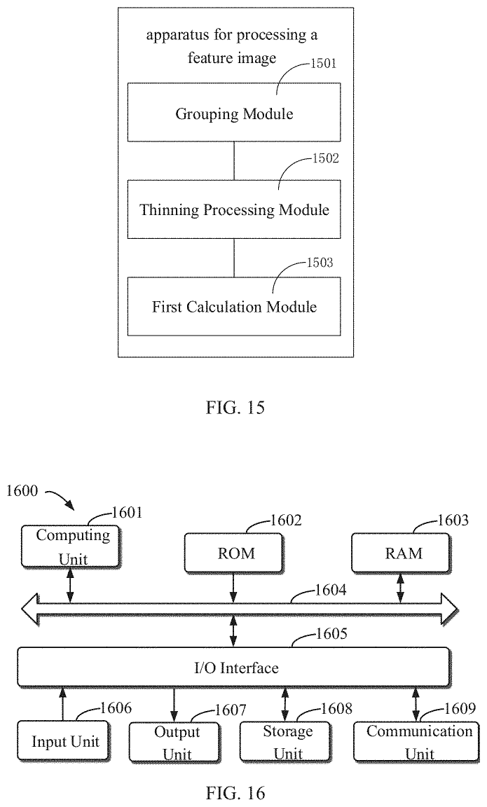

As shown in FIG. 15, the present disclosure relates to an apparatus for processing a feature image, which may include:

a grouping module 1501 configured to group parameters in a parameter matrix to obtain a plurality of arrays: the parameter matrix being a matrix converted and obtained from a convolutional layer in a convolutional neural network:

a thinning processing module 1502 configured to perform thinning processing on the parameter matrix according to parameter values in the plurality of arrays to obtain a thinned parameter matrix:

a first calculation module 1503 configured to perform calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

In one embodiment, the grouping module 1501 includes:

an intermediate matrix determination submodule configured to divide the parameter matrix by rows according to a preset number of rows to obtain a plurality of intermediate matrices;

a first array determination submodule configured to divide the intermediate matrices into a plurality of arrays by columns in the case where the number of rows of the intermediate matrices is equal to the preset number of rows; the preset number of rows of parameters being contained in the arrays.

In one embodiment, the grouping module 1501 includes:

the intermediate matrix determination submodule configured to divide the parameter matrix by rows according to a preset number of rows to obtain a plurality of intermediate matrices;

an one-dimensional matrix determination submodule configured to divide the intermediate matrices into at least one one-dimensional matrix by rows in the case where the number of rows of the intermediate matrices is less than the preset number of rows;

a second array determination submodule configured to divide each of the one-dimensional matrices into a plurality of arrays by columns; one parameter being contained in each of the arrays.

In one embodiment, the thinning processing module 1502 includes:

an array value determination submodule configured to perform sum calculation of the parameter values in each array, respectively, and to use the obtained result of the sum calculation as an array value;

a zero setting execution submodule configured to set all the parameter values in the arrays to zero to obtain a zeroed array in the case where the array value is less than a preset threshold;

a thinned parameter matrix determination submodule configured to use a matrix composed of the zeroed array and a non-zero array as the thinned parameter matrix; wherein the non-zero array is an array, the array value of which is not zero.

In one embodiment, the first calculation module 1503 includes:

a non-zero array position determination submodule configured to determine positions of a number M of non-zero arrays in the thinned parameter matrix; M being an integer not less than 1;

a first relevant data reading submodule configured to read a first relevant data in the data matrix based on the position of the jth non-zero array: the first relevant data being data in the data matrix, which is determined based on a preset rule and calculated together with the jth non-zero array; j being an integer not less than 1 and not greater than M:

a calculation submodule configured to perform calculation by using the jth non-zero array and the first relevant data to obtain the jth group of calculation results in the number M of groups of calculation results; the jth group of calculation results comprising at least one one-dimensional matrix in the jth non-zero array, which is calculated and obtained with the respective parameters, respectively, together with the first relevant data;

an output feature map execution submodule configured to determine the output feature map corresponding to the convolutional layer by using the number M of groups of calculation results.

In one embodiment, the output feature map execution submodule includes:

an one-dimensional matrix selection submodule configured to select at least one one-dimensional matrix corresponding to a target position parameter in the number M of groups of calculation results; the target position parameter being a parameter in the jth non-zero array, which is located at a target row number;

a target data determination submodule configured to determine target data by using the at least one one-dimensional matrix; the target data being the data in an output matrix, which is located at the target row number;

a post-processing submodule configured to perform preset post-processing on the output matrix to obtain the output feature map corresponding to the convolutional layer.

In one embodiment, the output feature map execution submodule further includes:

a data prefetching submodule configured to write a second relevant data in the data matrix into a cache memory in the course of performing calculation by using the jth non-zero array and the first relevant data: wherein the second relevant data is data, which is determined based on the preset rule and calculated together with the j+1th non-zero array.

In one embodiment, the data prefetching submodule includes:

a column number determination submodule configured to determine the column number of the j+1th non-zero array;

a row offset amount determination submodule configured to determine a row offset amount between the second relevant data and the first relevant data based on the column number difference between the column number of the j+1th non-zero array and the column number of the jth non-zero array;

a second relevant data determination submodule configured to determine the position of the second relevant data based on the position of the first relevant data and the row offset amount.

In one embodiment, the first calculation module 1503 includes:

a block processing submodule configured to perform block processing on the data matrix to obtain a number N of block matrices, wherein N is an integer not less than 1;

a block calculation submodule configured to perform calculation by using the thinned parameter matrix together with the number N of block matrices, respectively.

In one embodiment, the block processing submodule includes:

a row number determination submodule configured to use the number of rows of the data matrix as the number of rows of each of the block matrices;

a column number determination submodule configured to determine the number of columns of each of the block matrices according to the capacity of the cache memory and the number of columns of the data matrix; the cache memory being configured to store the parameter matrix and the block matrices;

a block processing execution submodule configured to perform block processing on the data matrix to obtain the number N of block matrices based on the number of rows and the number of columns of each of the block matrices.

In one embodiment, the apparatus for processing a feature image further includes:

a second calculation module configured to perform calculation by using the parameter matrix and the data matrix in the case where the sparsity of the thinned parameter matrix does not satisfy the predetermined condition.

In the technical solution of the present disclosure, acquisition, storage, application and the like of user personal information involved are all in compliance with relevant laws and regulations, and do not violate public order and good customs.

According to the embodiments of the present disclosure, the present disclosure also provides an electronic device, a readable storage medium, and a computer program product.

FIG. 16 shows a schematic block diagram of an example electronic device 1600 that may be used to implement embodiments of the present disclosure. An electronic device is intended to represent various forms of digital computers, such as laptops, desktops, workstations, personal digital assistants, servers, blade servers, mainframes, and other suitable computers. An electronic device may also represent various forms of mobile apparatuses, such as personal digital processing, cellular telephones, smart phones, wearable devices, and other similar computing apparatuses. The components shown herein, their connections and relationships, and their functions, are by way of example only, and are not intended to limit implementations of the present disclosure described and/or claimed herein.

As shown in FIG. 16, a device 1600 includes a computing unit 1601 that can perform various appropriate actions and processes according to a computer program stored in a read-only memory (ROM) 1602 or a computer program loaded from a storage unit 1608 into a random access memory (RAM) 1603. Various appropriate actions and processes are performed. In the RAM 1603, various programs and data necessary for the operation of the device 1600 can also be stored. The computing unit 1601, the ROM 1602, and the RAM 1603 are connected to each other through a bus 1604. An input/output (I/O) interface 1605 is also connected to the bus 1604.

Multiple components in the device 1600 are connected to the I/O interface 1605, including: an input unit 1606, such as a keyboard, a mouse, etc.; an output unit 1607, such as various types of displays, speakers, etc.: a storage unit 1608, such as a magnetic disk, an optical disk, and the like; and a communication unit 1609, such as a network card, a modem, a wireless communication transceiver, and the like. The communication unit 1609 allows the device 1600 to exchange information/data with other devices through a computer network such as the Internet and/or various telecommunication networks.

The computing unit 1601 may be various general-purpose and/or special-purpose processing components having processing and computing capabilities. Some examples of the computing unit 1601 include, but are not limited to, central processing units (CPUs), graphics processing units (GPUs), various dedicated artificial intelligence (AI) computing chips, various computing units that run machine learning model algorithms, digital signal processing processor (DSP), and any suitable processors, controllers, microcontrollers, and the like. The computing unit 1601 executes various methods and processes described above, such as the method for processing a feature image. For example, in some embodiments, the method for processing a feature image may be implemented as computer software programs, which are tangibly included in a machine-readable medium, such as the storage unit 1608. In some embodiments, part or all of the computer programs can be loaded and/or installed on the electronic device 1600 via the ROM 1602 and/or the communication unit 1609. When the computer program is loaded into the RAM 1603 and executed by the computing unit 1601, one or more steps of the method for processing a feature image described above may be executed. Alternatively, in other embodiments, the computing unit 1601 may be configured to execute the method for processing a feature image in any other appropriate manner (for example, by means of firmware).

Various embodiments of the systems and techniques described above herein can be implemented in digital electronic circuit systems, integrated circuit systems, field programmable gate arrays (FPGAs), application specific integrated circuits (ASICs), application specific standard products (ASSPs), system of System-On-Chip (SOC), Load Programmable Logic Device (CPLD), computer hardware, firmware, software, and/or combinations thereof. These various embodiments may include: being implemented in one or more computer programs, which can be executed and/or interpreted on a programmable system including at least one programmable processor, and the programmable processor may be a special-purpose or a general-purpose programmable processor, can receive data and instructions from a storage system, at least one input device, and at least one output device, and transmit data and instructions to this storage system, this at least one input device, and this at least one output device.

Program codes for implementing the methods of the present disclosure may be written in any combination of one or more programming languages. These program codes may be provided to a processor or a controller of a general-purpose computer, a special purpose computer, or other programmable data processing devices, so that the program codes, when executed by the processor or the controller, cause functions/operations specified in the flow diagrams and/or the block diagrams to be implemented. The program codes may be executed entirely on a machine, partly on a machine, as a stand-alone software package partly on a machine and partly on a remote machine or entirely on the remote machine or a server.

In the context of the present disclosure, the machine-readable medium may be a tangible medium that may contain or store a program for use by or in conjunction with an instruction execution system, an apparatus, or a device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media would include electrical connections based on one or more wires, portable computer disks, hard disks, Random Access Memories (RAMs), Read Only Memories (ROMs), Erasable Programmable Read Only Memories (EPROMs or flash memories), fiber optics, portable compact disk read-only memories (CD-ROMs), optical storage devices, magnetic storage devices, or any suitable combination of the foregoing.

To provide for interaction with a user, the systems and techniques described here can be implemented on a computer, which has: a display device (for example, a CRT (cathode ray tube) or LCD (liquid crystal display) monitor) for displaying information to the user: and a keyboard and pointing device (for example, a mouse or a trackball), through which the user can provide input to the computer. Other kinds of devices may also be used to provide interaction with the user; for example, feedback provided to the user may be any form of sensory feedback (for example, visual feedback, auditory feedback, or tactile feedback): and input from the user may be received in any form (including acoustic input, voice input, or tactile input).

The systems and techniques described here may be implemented in a computing system (for example, as a data server) that includes back-end components, or a computing system (for example, an application server) that includes middleware components, or a computing system (for example, a user computer having a graphical user interface or a web browser, through which a user can interact with embodiments of the systems and techniques described here) that includes front-end components, or a computing system that includes any combination of such back-end components, middleware components, or front-end components. The components of the system can be interconnected by any form or medium of digital data communication (for example, a communication network). Examples of the communication network include: local area networks (LANs), wide area networks (WANs), and the Internet.

The computer system may include clients and servers. Clients and servers are generally remote from each other and typically interact through a communication network. The relationship of client and server will be generated by computer programs running on the respective computers and having a client-server relationship to each other. The server may be a cloud server, may also be a server of a distributed system, or a server combined with a blockchain.

It should be understood that steps may be reordered, added or deleted using the various forms of flow shown above. For example, the respective steps disclosed in the present disclosure may be executed in parallel, may also be executed sequentially, or may also be executed in a different order, as long as the desired result of the technical solutions disclosed in the present disclosure can be achieved, and no limitation is imposed thereto herein.

The specific embodiments described above do not constitute a limitation on the protection scope of the present disclosure. It should be apparent to those skilled in the art that various modifications, combinations, sub-combinations and substitutions may be made depending on design requirements and other factors. Any modifications, equivalent replacements and improvements made within the spirit and the principle of the present disclosure shall be included within the protection scope of the present disclosure.

What is claimed is:

1. A method for processing a feature image, comprising:
grouping parameters in a parameter matrix to obtain a plurality of arrays; the parameter matrix being a matrix converted and obtained from a convolutional layer in a convolutional neural network;
performing thinning processing on the parameter matrix according to parameter values in the plurality of arrays to obtain a thinned parameter matrix;
performing calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

2. The method according to claim 1, wherein the grouping the parameters in the parameter matrix comprises:
dividing the parameter matrix by rows according to a preset number of rows to obtain a plurality of intermediate matrices;
dividing the intermediate matrices into a plurality of arrays by columns in the case where the number of rows of the intermediate matrices is equal to the preset number of rows: the preset number of rows of parameters being contained in the arrays.

3. The method according to claim 1, wherein the grouping the parameters in the parameter matrix comprises:
dividing the parameter matrix by rows according to a preset number of rows to obtain a plurality of intermediate matrices;
dividing the intermediate matrices into at least one one-dimensional matrix by rows in the case where the number of rows of the intermediate matrices is less than the preset number of rows;
dividing each of the one-dimensional matrices into a plurality of arrays by columns; one parameter being contained in each of the arrays.

4. The method according to claim 1, wherein the performing thinning processing on the parameter matrix according to the parameter values in the plurality of arrays to obtain the thinned parameter matrix comprises:
performing summation calculation of the parameter values in each array, respectively, and using the obtained result of the summation calculation as an array value;
setting all the parameter values in the arrays to zero to obtain a zeroed array in the case where the array value is less than a preset threshold;
using a matrix composed of the zeroed array and a non-zero array as the thinned parameter matrix; wherein the non-zero array is an array, the array value of which is not zero.

5. The method according to claim 4, wherein the performing calculation by using the thinned parameter matrix and the data matrix to determine the output feature map corresponding to the convolutional layer comprises:
determining positions of a number M of non-zero arrays in the thinned parameter matrix; M being an integer not less than 1;
reading a first relevant data in the data matrix based on the position of the jth non-zero array; the first relevant data being data in the data matrix, which is determined based on a preset rule and calculated together with the jth non-zero array: j being an integer not less than 1 and not greater than M;
performing calculation by using the jth non-zero array and the first relevant data to obtain the jth group of calculation results in the number M of groups of calculation results: the jth group of calculation results comprising at least one one-dimensional matrix in the jth non-zero array, which is calculated and obtained with the respective parameters, respectively, together with the first relevant data;
determining the output feature map corresponding to the convolutional layer by using the number M of groups of calculation results.

6. The method according to claim 5, wherein the determining the output feature map corresponding to the convolutional layer by using the number M of groups of calculation results comprises:
selecting at least one one-dimensional matrix corresponding to a target position parameter in the number M of groups of calculation results; the target position parameter being a parameter in the jth non-zero array, which is located at a target row number;
determining target data by using the at least one one-dimensional matrix; the target data being the data in an output matrix, which is located at the target row number;
performing preset post-processing on the output matrix to obtain the output feature map corresponding to the convolutional layer.

7. The method according to claim 6, further comprising:
writing a second relevant data in the data matrix into a cache memory in the course of performing calculation by using the jth non-zero array and the first relevant data; wherein the second relevant data is data, which is determined based on the preset rule and calculated together with the j+1th non-zero array.

8. The method according to claim 7, wherein the determining method of the second relevant data comprises:
determining the column number of the j+1th non-zero array;
determining a row offset amount between the second relevant data and the first relevant data based on the column number difference between the column number of the j+1th non-zero array and the column number of the jth non-zero array;
determining the position of the second relevant data based on the position of the first relevant data and the row offset amount.

9. The method according to claim 1, wherein the performing calculation by using the thinned parameter matrix and the data matrix comprises:
performing block division processing on the data matrix to obtain a number N of block division matrices, wherein N is an integer not less than 1;
performing calculation by using the thinned parameter matrix together with the number N of block division matrices, respectively.

10. The method according to claim 9, wherein the performing block division processing on the data matrix comprises:
using the number of rows of the data matrix as the number of rows of each of the block division matrices;
determining the number of columns of each of the block division matrices according to the capacity of the cache memory and the number of columns of the data matrix: the cache memory being configured to store the parameter matrix and the block division matrices;
performing block division processing on the data matrix to obtain the number N of block division matrices based on the number of rows and the number of columns of each of the block division matrices.

11. The method according to claim 1, further comprising:
performing calculation by using the parameter matrix and the data matrix in the case where the sparsity of the thinned parameter matrix does not satisfy the predetermined condition.

12. An electronic device, comprising:
a processor; and
a memory communicatively connected to the processor; wherein,
the memory is configured to store instructions executable by the processor and the processor is configured to execute instructions to:
group parameters in a parameter matrix to obtain a plurality of arrays: the parameter matrix being a matrix converted and obtained from a convolutional layer in a convolutional neural network;
perform thinning processing on the parameter matrix according to parameter values in the plurality of arrays to obtain a thinned parameter matrix;
perform calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.

13. The electronic device according to claim 12, wherein the processor is configured to execute instructions to:
divide the parameter matrix by rows according to a preset number of rows to obtain a plurality of intermediate matrices;
divide the intermediate matrices into a plurality of arrays by columns in the case where the number of rows of the intermediate matrices is equal to the preset number of rows; the preset number of rows of parameters being contained in the arrays.

14. The electronic device according to claim 12, wherein the processor is configured to execute instructions to:
divide the parameter matrix by rows according to a preset number of rows to obtain a plurality of intermediate matrices;
divide the intermediate matrices into at least one one-dimensional matrix by rows in the case where the number of rows of the intermediate matrices is less than the preset number of rows;
divide each of the one-dimensional matrices into a plurality of arrays by columns; one parameter being contained in each of the arrays.

15. The electronic device according to claim 12, wherein the processor is configured to execute instructions to:
perform summation calculation of the parameter values in each array, respectively, and using the obtained result of the summation calculation as an array value;
set all the parameter values in the arrays to zero to obtain a zeroed array in the case where the array value is less than a preset threshold;
use a matrix composed of the zeroed array and a non-zero array as the thinned parameter matrix; wherein the non-zero array is an array, the array value of which is not zero.

16. The electronic device according to claim 15, wherein the processor is configured to execute instructions to:
determine positions of a number M of non-zero arrays in the thinned parameter matrix: M being an integer not less than 1;
read a first relevant data in the data matrix based on the position of the jth non-zero array: the first relevant data being data in the data matrix, which is determined based on a preset rule and calculated together with the jth non-zero array: j being an integer not less than 1 and not greater than M;
perform calculation by using the jth non-zero array and the first relevant data to obtain the jth group of calculation results in the number M of groups of calculation results; the jth group of calculation results comprising at least one one-dimensional matrix in the jth non-zero array, which is calculated and obtained with the respective parameters, respectively, together with the first relevant data;
determine the output feature map corresponding to the convolutional layer by using the number M of groups of calculation results.

17. The electronic device according to claim 16, wherein the processor is configured to execute instructions to:
select at least one one-dimensional matrix corresponding to a target position parameter in the number M of groups of calculation results; the target position parameter being a parameter in the jth non-zero array, which is located at a target row number;
determine target data by using the at least one one-dimensional matrix: the target data being the data in an output matrix, which is located at the target row number;
perform preset post-processing on the output matrix to obtain the output feature map corresponding to the convolutional layer.

18. The electronic device according to claim 17, wherein the processor is configured to execute instructions to:
write a second relevant data in the data matrix into a cache memory in the course of performing calculation by using the jth non-zero array and the first relevant data; wherein the second relevant data is data, which is determined based on the preset rule and calculated together with the j+1th non-zero array.

19. The electronic device according to claim 18, wherein the processor is configured to execute instructions to:
determine the column number of the j+1th non-zero array;
determine a row offset amount between the second relevant data and the first relevant data based on the column number difference between the column number of the j+1th non-zero array and the column number of the jth non-zero array,
determine the position of the second relevant data based on the position of the first relevant data and the row offset amount.

20. A non-transitory computer-readable storage medium storing computer instructions, wherein the computer instructions are configured to cause a computer to execute a method for processing a feature image, the method comprising:
grouping parameters in a parameter matrix to obtain a plurality of arrays; the parameter matrix being a matrix converted and obtained from a convolutional layer in a convolutional neural network;
performing thinning processing on the parameter matrix according to parameter values in the plurality of arrays to obtain a thinned parameter matrix;
performing calculation by using the thinned parameter matrix and a data matrix to determine an output feature map corresponding to the convolutional layer in the case where a sparsity of the thinned parameter matrix satisfies a predetermined condition; the data matrix including a matrix converted and obtained from an input feature map inputted into the convolutional layer.
